(19) United States
(12) Patent Application Publication
(10) Pub. No.: US 2020/0333688 A1
(43) Pub. Date: Oct. 22, 2020

(54) PORTABLE, FOLDABLE, WASHABLE FABRIC PHOTOGRAPHY BACKDROP AND METHOD OF USE THEREOF

(71) Applicant: Sarah COLLIER, Mint Hill, NC (US)

(72) Inventor: Sarah COLLIER, Mint Hill, NC (US)

(21) Appl. No.: 16/389,161

(22) Filed: Apr. 19, 2019

(51) Int. Cl. G03B 15/00

(52) U.S. Cl. CPC G03B 15/00

(57) ABSTRACT

A portable, foldable, washable photography backdrop includes a cover and a base frame. The cover includes a first side and a second side with a pocket created therebetween. The base frame is sized and shaped to fit in the pocket of the cover. The base frame is collapsible to reconfigure the photography backdrop from a deployed backdrop state wherein the base frame supports the cover in a generally flat state to a compact state wherein the cover is folded.

### FIELD OF THE DISCLOSURE

The present disclosure relates to backdrops for photographers or for photography. More specifically, the present disclosure relates to a portable, foldable, washable fabric photography backdrop and a method of use thereof.

### BACKGROUND

Generally speaking, photography backdrops have been a standard feature of photography studios. One of the biggest challenges any photographer faces is finding the perfect backdrop. Technically, a backdrop refers to anything that can be used to enhance the look of the photograph. Put simply, the filling in of a background is the backdrop, which must be considered carefully to get it right. A standard backdrop can range from a solid color muslin material in black, red, white or any other color you choose, to ones that feature artistic images of landscapes or buildings. A backdrop and the lighting will work together to create a quality picture. In most cases, your backdrop will be a physical item that you can use inside of a studio or take with you to an outdoor photography shoot.

Standard backdrops are designed to be used in studios where they are permanently installed. With the evolution of cameras, photographers of the modern times can be more mobile and take pictures in various locations and lightings. As such, the instant disclosure recognizes the need to provide a portable photography backdrop. Although there are some photography backdrops that are portable, these backdrops are typically bulky and difficult to transport. As such, the instant disclosure recognizes the need to provide a photography backdrop that is easier to transport. Furthermore, these known portable backdrops are prone to get dirty and blemished during transportation to mobile photography sites and during use at the mobile photography sites, like in the outdoors. As such, the instant disclosure also recognizes the need to provide a photography backdrop that is washable.

The instant disclosure may be designed to address certain aspects of the needs and/or problems discussed above by providing a portable, foldable, washable photography backdrop and a method of use thereof.

### SUMMARY

In accordance with at least select embodiments, the instant disclosure may address at least certain aspects of the above mentioned needs, issues and/or problems and may provide a portable, foldable, washable photography backdrop and a method of use thereof. Accordingly, in one aspect, the present disclosure may generally embrace a photography backdrop that may include a cover and a base frame. The cover may include a first side and a second side with a pocket created therebetween. The base frame may be sized and shaped to fit in the pocket of the cover. The base frame may be collapsible to reconfigure the photography backdrop from a deployed backdrop state wherein the base frame supports the cover in a generally flat state to a compact state wherein the cover is folded.

One feature of the disclosed photography backdrop may be that when the photography backdrop is in the deployed backdrop state, the base frame stretches the cover into the generally flat state, whereby the photography backdrop may be positioned where the first side or the second side may be a photography backdrop.

Another feature of the disclosed photography backdrop may be that when the photography backdrop is in the compact state, the photography backdrop may be portable.

In select embodiments of the disclosed photography backdrop, the first side my have a first face with a first color, a first pattern, a first texture, or a first combination thereof.

In other select embodiments of the disclosed photography backdrop, the second side may have a second face with a second color, a second pattern, a second texture, or a second combination thereof.

One feature of the disclosed photography backdrop may be that in select embodiments the first face may be different from the second face. As a result, the disclosed photography backdrop may include two different faces configured for providing two different photography backdrops.

Another feature of the disclosed photography backdrop may be that the cover can be made from a fabric material. In select embodiments, the first side may be made from a first fabric material, and the second side may be made from a second fabric material. The first fabric material may include a first face with a first color, a first pattern, or a first texture, and the second fabric material may include a second face with a second color, a second pattern, or a second texture. As a result, in select embodiments, the first face may be different from the second face, whereby the photography backdrop includes two different faces configured for providing two different photography backdrops.

In select embodiments of the disclosed photography backdrop, the first side may have a first perimeter, and the second side may have a second perimeter. Wherein, the first perimeter of the first side and the second perimeter of the second side may be connected together with the pocket created therebetween inside the cover. In select embodiments of the disclosed photography backdrop, the first side may be made from a first fabric material, and the second side may be made from a second fabric material. Wherein, the first perimeter of the first side and the second perimeter of the second side may be sewn together by a sewn connection with the pocket created therebetween inside the cover.

Another feature of the disclosed photography backdrop may be that the first perimeter of the first side and the second perimeter of the second side may be connected together with an openable portion. The openable portion may be configured for inserting and removing the base frame into and out of the pocket of the cover. In select embodiments, the openable portion may include a zippered opening. The zippered opening may be configured to unzip for inserting and removing the base frame into and out of the pocket of the cover. As a result, another feature of the disclosed photography backdrop may be that the base frame can be removable from the cover, whereby the cover can be configured to be washed.

In select embodiments of the disclosed photography backdrop, the cover and the base frame may have a circular shape or an oval shape.

Another feature of the disclosed photography backdrop may be the inclusion of a hanging mechanism. The hanging mechanism may be configured to hang the photography backdrop on a surface. In select embodiments, the hanging mechanism may include at least one loop connected to the cover, including, but not limited to, two loops connected to the cover.

In select embodiments of the disclosed photography backdrop, the base frame may be twistable into a plurality of stacked loops to reconfigure the frame from the deployed backdrop state to the compact state, and vice versa.

In another aspect, the instant disclosure is directed toward a cover for a portable, foldable, washable photography backdrop. The cover for the portable foldable, washable photography backdrop may be any of the various embodiments of the cover shown and/or described herein. As a result, in select embodiments, the cover may include a first side and a second side with a pocket created therebetween. The pocket may be configured to receive a base frame collapsible to reconfigure the cover from a deployed backdrop state wherein the base frame supports the cover in a generally flat state to a compact state wherein the cover is folded.

In select embodiments of the disclosed cover for a portable, foldable, washable photography backdrop, the first side may be made from a first fabric material. The first fabric material may include a first face with a first color, a first pattern, and/or a first texture.

In other select embodiments of the disclosed cover for a portable, foldable, washable photography backdrop, the second side may be made from a second fabric material. The second fabric material may include a second face with a second color, a second pattern, and/or a second texture.

One feature of the disclosed cover for a portable, foldable, washable photography backdrop may be that the first face may be different from the second face, whereby the cover includes two different faces configured for providing two different photography backdrops.

In select embodiments of the disclosed cover for a portable foldable, washable photography backdrop, the first side may have a first perimeter, and the second side may have a second perimeter. Wherein, the first perimeter of the first side and the second perimeter of the second side may be sewn together by a sewn connection with the pocket created therebetween inside the cover.

Another feature of the disclosed cover for a portable, foldable, washable photography backdrop may be that the first perimeter of the first side and the second perimeter of the second side may be connected together with an openable portion. The openable portion may be configured for inserting and removing the base frame into and out of the pocket of the cover. In select embodiments, the openable portion may include a zippered opening configured to unzip for inserting and removing the base frame into and out of the pocket of the cover.

Another feature of the disclosed cover for a portable, foldable, washable photography backdrop may be that the cover can be configured to be washed.

Another feature of the disclosed cover for a portable, foldable, washable photography backdrop may be the inclusion of a hanging mechanism. The hanging mechanism may be configured to hang the cover on a surface. In select embodiments, the hanging mechanism may include at least one loop connected to the cover, including, but not limited to, two loops connected to the cover.

In another aspect, the instant disclosure embraces a method of using a photography backdrop. The disclosed method of using a photography backdrop may generally include providing the portable, foldable, washable photography backdrop in any of the various embodiments shown and/or described herein. As such, the provided photography backdrop may include a cover and a base frame. The cover may include a first side and a second side with a pocket created therebetween. The base frame may be sized and shaped to fit in the pocket of the cover. The base frame may be collapsible to reconfigure the photography backdrop from a deployed backdrop state wherein the base frame supports the cover in a generally flat state to a compact state wherein the cover is folded. As a result, the disclosed method of using a photography backdrop may further include: inserting the base frame into the pocket of the cover; unfolding the base frame into the generally flat state for use as a photography backdrop; and folding the base frame into the compact state for transportation.

In select embodiments of the disclosed method of using a photography backdrop, the method may further include placing the photography backdrop on the ground or hanging the photography backdrop via a hanging mechanism including on the cover.

In select embodiments of the disclosed method of using a photography backdrop, the method may further include removing the base frame from the pocket of the cover; and washing the cover.

In other select embodiments of the disclosed method of using a photography backdrop, the step of folding the base frame into the compact state for transportation may include twisting the base frame into a plurality of stacked loops to reconfigure the frame from the deployed backdrop state to the compact state.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 illustrates an environmental perspective view of the portable, foldable, washable photograph backdrop according to select embodiments of the instant disclosure, where the user is holding the twisted base and cover separately;

FIG. 2 illustrates another environmental perspective view of the portable, foldable, washable photograph backdrop of FIG. 1, where the user is untwisting the base;

FIG. 3 illustrates another environmental perspective view of the portable, foldable, washable photograph backdrop of FIG. 1, where the user has unzipped the cover and is beginning to put the cover over the untwisted base;

FIG. 4 illustrates another environmental perspective view of the portable, foldable, washable photograph backdrop of FIG. 1, where the user has inserted the untwisted base into the cover and is beginning to zip the cover closed;

FIG. 5 illustrates another environmental perspective view of the portable, foldable, washable photograph backdrop of FIG. 1, where the user has inserted the untwisted base into the cover and has zipped the cover closed;

FIG. 6 illustrates another environmental perspective view of the portable, foldable, washable photograph backdrop of FIG. 1, where the user has is twisting the base with the cover thereon into a portable form;

FIG. 7 illustrates another environmental perspective view of the portable, foldable, washable photograph backdrop of FIG. 1, where the user has twisted the base with the cover thereon together and is inserting them together into a bag for transporting it;

FIG. 8 illustrates a front environmental perspective view of the portable, foldable, washable photograph backdrop according to select embodiments of the instant disclosure being used as a backdrop for a floral arrangement for a photographer where the portable, foldable, washable photograph backdrop is hung on a wall with the hangers;

FIG. 9 illustrates a front environmental perspective view of the portable, foldable, washable photograph backdrop according to select embodiments of the instant disclosure being used as a backdrop for a floral arrangement where the portable, foldable, washable photograph backdrop is laying flat on the ground; and

FIG. 10 illustrates a flow chart of the method of using a photography backdrop according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

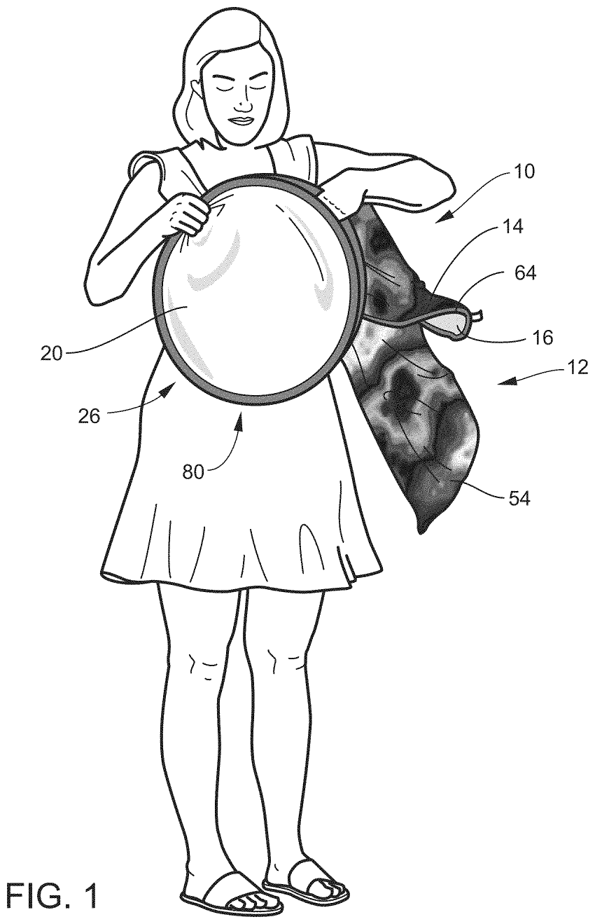

Referring now to FIGS. 1-10, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

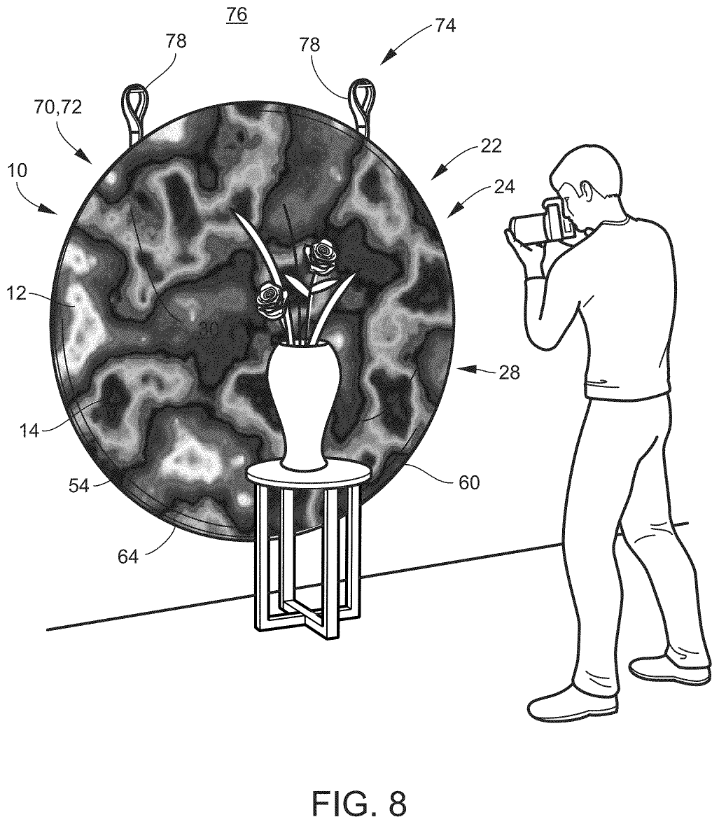

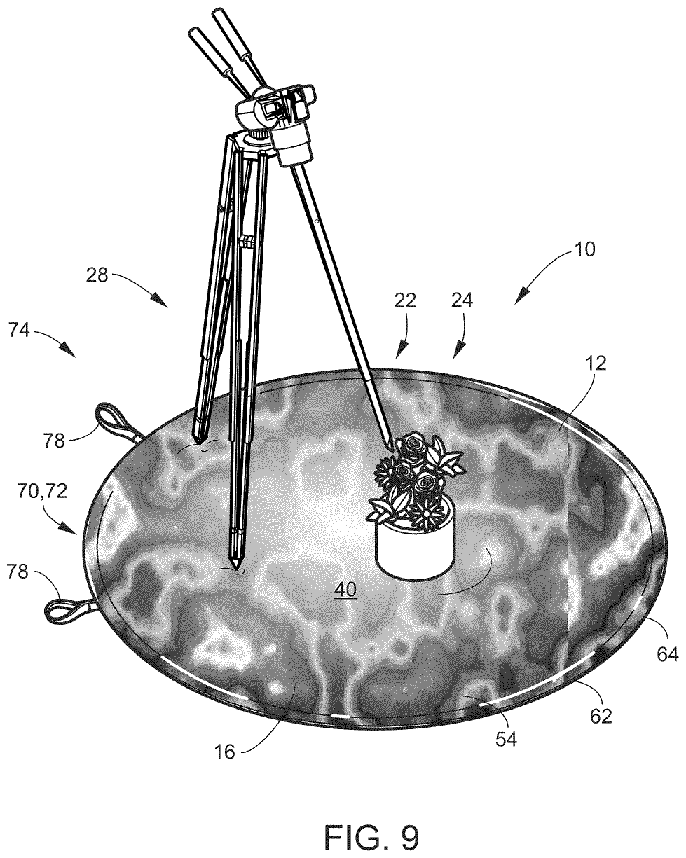

Referring now to FIGS. 1-9, in a possibly preferred embodiment, the present disclosure overcomes the above-mentioned disadvantages and meets the recognized need for such an apparatus or method by providing of portable, foldable, washable photography backdrop 10. Portable, foldable, washable photograph backdrop 10, which may be referred to herein as just photography backdrop 10 or even shorter as backdrop 10, may be for providing a background or backdrop for photos or photography. As examples, as shown in FIG. 8, photography background 10 may be hung on a wall or surface 76 for placing an object, like a floral arrangement in front of it for photographing the floral arrangement. As another example, as shown in FIG. 9, photography background 10 may be placed or positioned on the ground or another surface for placing an object, like a floral arrangement, or other object, like wedding pieces, products, or the like, for photographing the objects on the photography backdrop. However, the disclosure is not so limited, and photography backdrop 10 may be used in any other desired ways, locations, or setups as a photography background, backdrop, or the like. As such, portable, foldable, washable photography backdrop may be used in many different ways as a photography backdrop. Portable, foldable, washable photography backdrop may generally include cover 12 and base frame 20. These two components and their functions will be described in greater detail below

Cover 12 may be included with portable, foldable, washable photography backdrop 10. Cover 12 may provide the material or materials, face or faces, or surface or surfaces for photography backdrop 10. Cover 12 may include first side 14 and second side 16. Pocket 18 may be created therebetween first side 14 and second side 16. In select embodiments, first side 14 my have first face 30 with first color 32, first pattern 34, first texture 36, or first combination 38 thereof. As such, first face 30 may be any various backdrop design, including any various solid colors like whites, greys, blacks, etc., any various patterns like marble patterns, stripes, etc., any various textures like flat, shiny, rough, bumpy, etc., or any various combinations thereof. Likewise, second side 16 may have second face 40 with second color 42, second pattern 44, second texture 46, or second combination thereof 48. As such, second face 40 may be any various backdrop design, including any various solid colors like whites, greys, blacks, etc., any various patterns like marble patterns, stripes, etc., any various textures like flat, shiny, rough, bumpy, etc., or any various combinations thereof. Accordingly, one feature of the disclosed photography backdrop may be that in select embodiments first face 30 may be different from second face 40. As a result, photography backdrop 10 may include two different faces 50 configured for providing two different photography backdrops 52.

Cover 12 can be made from any desired material or materials. In select embodiments, as shown in the Figures, cover 12 can be made from fabric material 54. As such, first side 14 may be made from first fabric material 56, and second side 16 may be made from second fabric material 58. First fabric material 56 may include first face 30 with first color 32, first pattern 34, and/or first texture 36 (as discussed above), and second fabric material 58 may include second face 40 with second color 42, second pattern 44, and/or second texture 46. As a result, in select embodiments, first fabric material 56 with first face 30 may be different from second fabric material 58 with second face 40. Whereby, photography backdrop 10 can include two different faces 50 configured for providing two different photography backdrops 52. First face 30 of first fabric material 56 and second face 40 of second fabric material 58 may be created by any means, including any printing, dying, weaving, sewing, manufacturing, or the like.

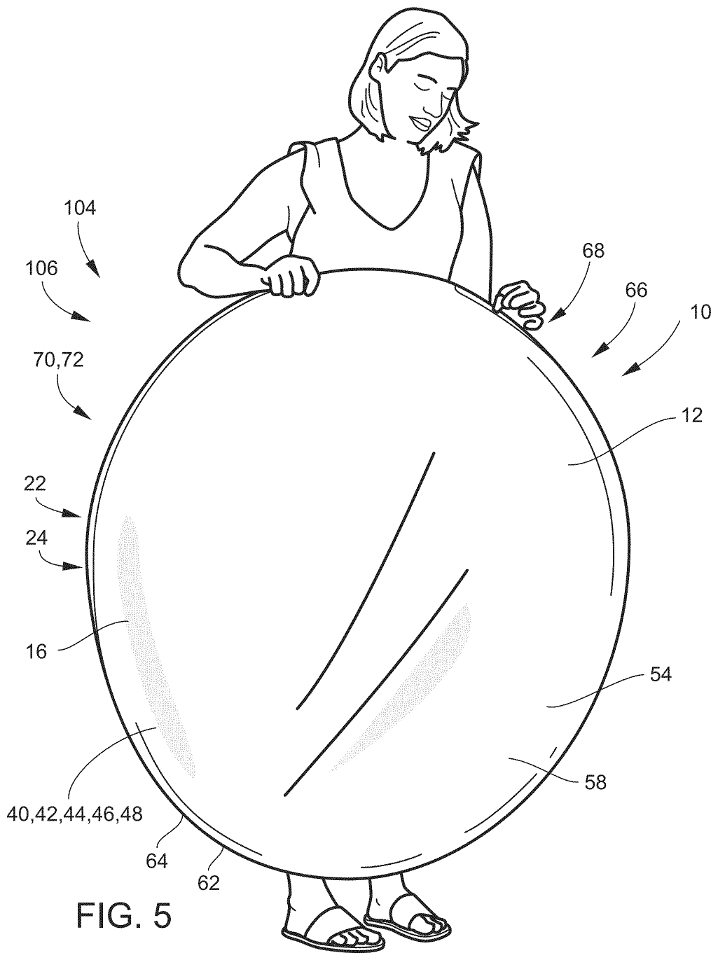

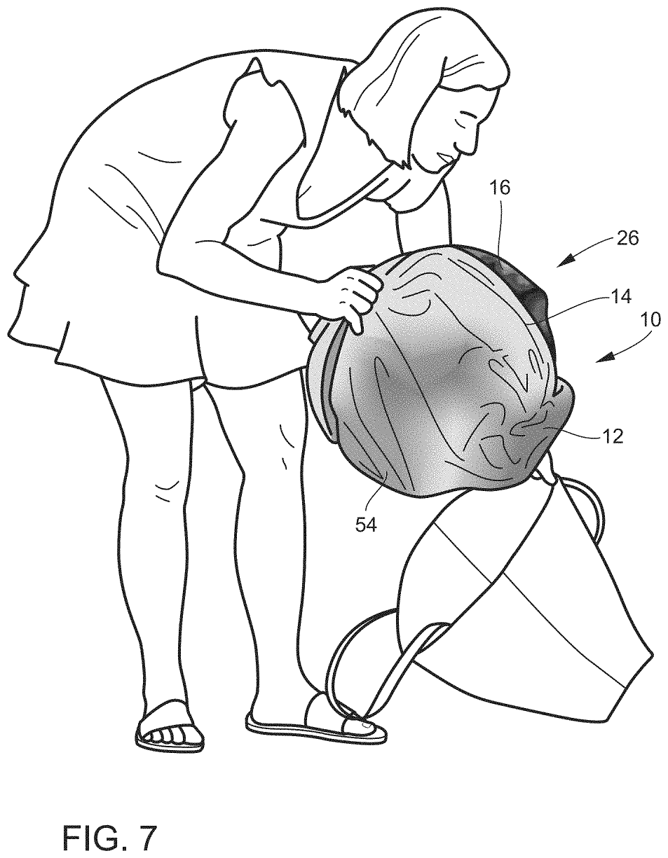

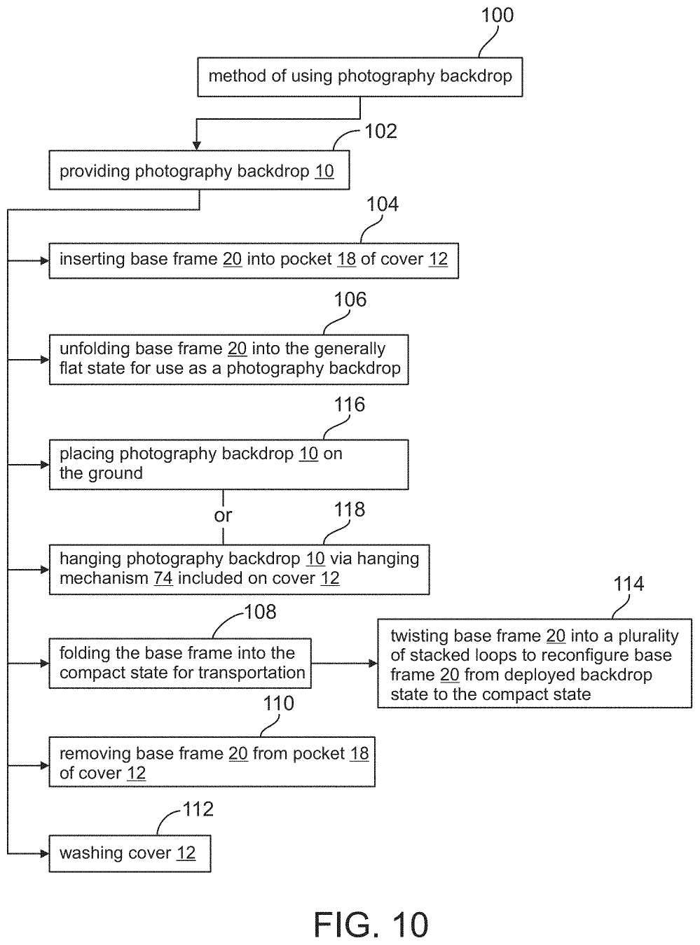

Base frame 20 may be included with portable, foldable, washable photography backdrop 10. Base frame 20 may be for providing the structure or support for cover 12 for creating photography backdrop 10. Base frame 20 may also provide for the foldability of photography backdrop 10. Base frame 20 may be sized and shaped to fit in pocket 18 of cover 12. Base frame 20 may be collapsible to reconfigure photography backdrop 10 from deployed backdrop state 22 (see FIGS. 5, 8 and 9) wherein the base frame supports cover 12 in generally flat state 24 to compact state 26 (see FIGS. 1 and 7) wherein cover 12 is folded. Base frame 20 may sized and configured to stretch cover 12 into generally flat state 24. As such, when unfolded in deployed backdrop state 22, cover 12 may be stretched flat with no or minimum wrinkles or folds. Whereby, photography backdrop 10 may be positioned where first side 14 or second side 16 may be photography backdrop 28 (see FIGS. 9 and 10). In addition, when photography backdrop is in compact state 26 (see FIGS. 1 and 7), photography backdrop 10 may be portable. As shown in FIG. 7, as an example, compact state 26 of photography backdrop 10 may be small enough to be carried in a purse or handback.

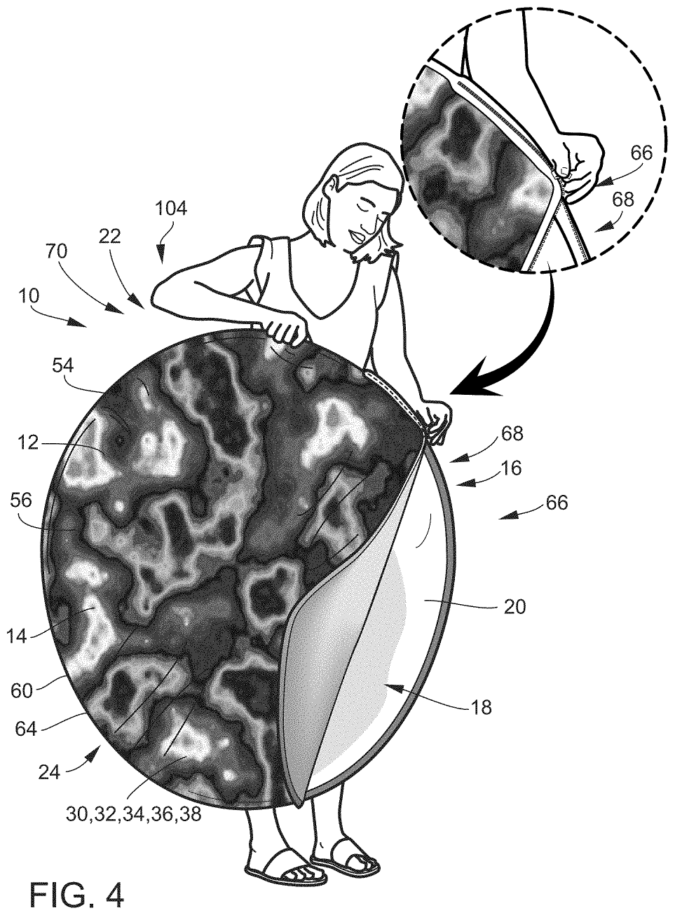

As best shown in FIGS. 4 and 5, in select embodiments of photography backdrop 10, first side 14 may have first perimeter 60 (see FIG. 4), and second side 16 may have second perimeter 62 (see FIG. 5). Wherein, first perimeter 60 of first side 14 and second perimeter 62 of second side 16 may be connected together with pocket 18 created therebetween inside cover 12 (best shown in FIG. 4). As shown in the Figures, in select embodiments, first perimeter 60 of first side 14 and second perimeter 62 of second side 16 may be sewn together by sewn connection 64 with pocket 18 created therebetween inside cover 12.

Referring now to FIGS. 4 and 5, in select embodiments first perimeter 60 of first side 14 and second perimeter 62 of second side 16 may be connected together with openable portion 66. Openable portion 66 may be configured for inserting and removing base frame 20 into and out of pocket 18 of cover 12. Openable portion 66 may be any opening in cover 12, including any adhesives, mechanical fasteners like buttons, snaps, hook and loop type fasteners, zippers, the like etc. In select embodiments, as best shown in FIG. 4 openable portion 66 may include zippered opening 68. Zippered opening 68 may be created at the connection point between first side 14 and second side 16. Zippered opening 68 may be configured to unzip for inserting and removing base frame 20 into and out of pocket 18 of cover 12. Zippered opening 68 may also zip shut to lock base frame 20 inside cover 12 in pocket 18. As a result, another feature of photography backdrop 10 may be that base frame 20 can be removable from cover 12. This removable feature may allow cover 12 to be configured to be washed, like being machine washed or dry cleaned, or to be more easily hand washed, or the like. This washable feature of cover 12 of photograph backdrop 10 may allow for easy cleaning and care of photograph backdrop 10 to allow it to be used multiple times and in any various desired location and circumstances.

Portable, foldable, washable backdrop 10 may be provided in many different sizes and shapes. In select embodiments of photography backdrop 10, as shown in the Figures, cover 12 and base frame 20 may have circular shape 70 or oval shape 72 for creating a circular or oval shape of photography backdrop 10. However, the disclosure is not so limited, and any other various sizes and shapes may be created.

Referring now specifically to FIGS. 8 and 9, another feature of photography backdrop 10 may be the inclusion of hanging mechanism 74. Hanging mechanism 74 may be configured to hang photography backdrop 10 on surface 76 or the like, or from any various structure or mechanism. Hanging mechanism 74 may include any various devices, mechanisms or means for hanging photography backdrop 10. In select embodiments, as shown in the Figures, hanging mechanism 74 may include at least one loop 78 connected to cover 12. Loop 78 may be configured to loop around an object, like a ledge, a protrusion, a hook, a nail, the like, etc. for hanging photography backdrop 10. Hanging mechanism 74 may include any desired number of loops 78 for hanging photography backdrop 10. In select possibly preferred embodiments, hanging mechanism 74 may include two loops 78 connected to cover 12 at spaced apart locations configured for hanging photography backdrop 10.

Base frame 20 and resultantly cover 12 and photography backdrop 10 may be configured to fold by any desired means. In select embodiments, as shown in FIGS. 1-7, base frame 20 may be twistable into a plurality of stacked loops 80 to reconfigure base frame 20 from the deployed backdrop state 22 to compact state 26, and vice versa. As such, base frame 20 may include a ring around its perimeter. This ring may be a flexible ring fabricated from steel that is configured to twist to create the plurality of stacked loops 80. As an example, and clearly not limited thereto, the steel of the ring may have a diameter of at least 1/16th of an inch

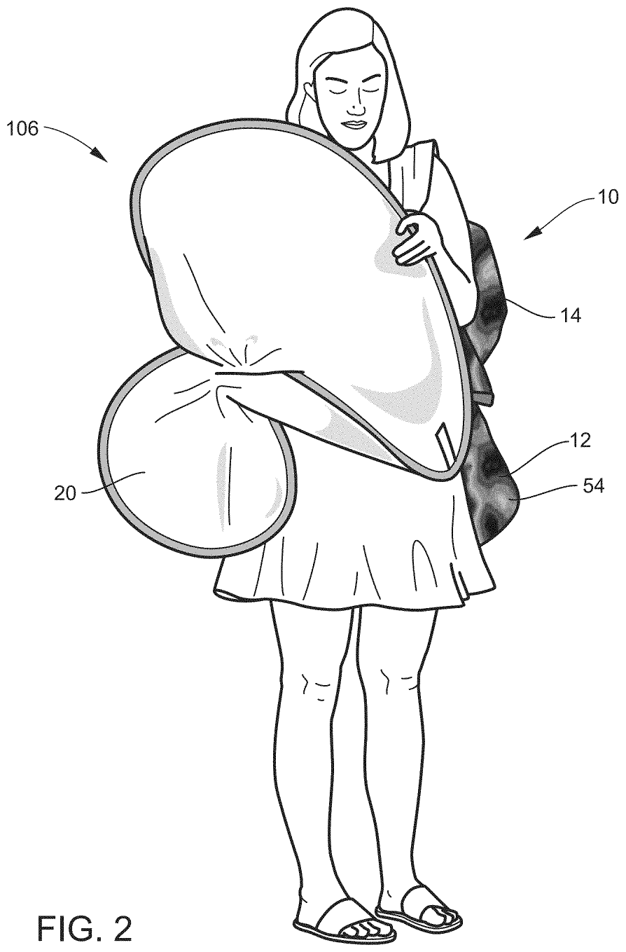

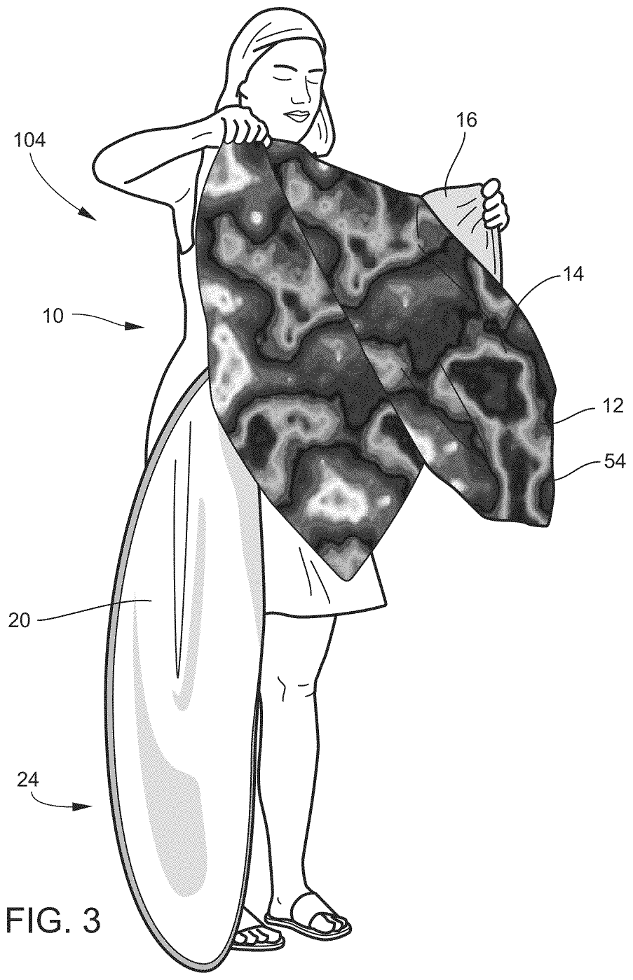

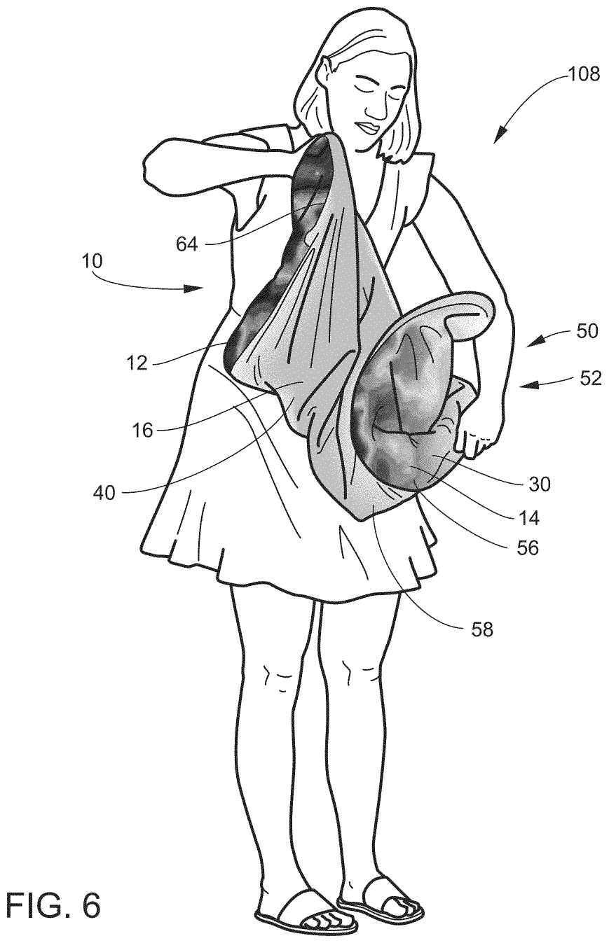

Referring now specifically to FIG. 10, in another aspect, the instant disclosure embraces method 100 of using a photography backdrop. Method 100 of using a photography backdrop may generally include step 102 of providing portable, foldable, washable photography backdrop 10 in any of the various embodiments shown and/or described herein. As such, the provided photography backdrop 10 may include cover 12 and base frame 20. Cover 12 may include first side 14 and second side 16 with pocket 18 created therebetween. Base frame 20 may be sized and shaped to fit in pocket 18 of cover 12. Base frame 20 may be collapsible to reconfigure photography backdrop 10 from deployed backdrop state 22 wherein base frame 20 supports cover 12 in generally flat state 24 to compact state 26 wherein cover 12 is folded. As a result, method 100 of using a photography backdrop may further include: step 104 of inserting base frame 20 into pocket 18 of cover 12 (see FIGS. 3-5); step 106 of unfolding base frame 20 into generally flat state 24 for use as photography backdrop 28 (see FIG. 2); and step 108 of folding base frame 20 into compact state 26 for transportation (see FIG. 6). In select embodiments of method 100 of using a photography backdrop, method 100 may further include step 116 of placing photography backdrop 10 on the ground or step 118 of hanging photography backdrop 10 via hanging mechanism 74 included on cover 12. In other select embodiments of method 100 of using a photography backdrop, method 100 may further include: step 110 of removing base frame 20 from pocket 18 of cover 12; and step 112 of washing cover 12. In other select embodiments of method 100, step 108 of folding base frame 20 into compact state 26 for transportation may include step 114 of twisting base frame 20 into plurality of stacked loops 80 to reconfigure base frame 20 from deployed backdrop state 22 to compact state 26.

In sum, the disclosed photograph backdrop 10 provides a portable, foldable, washable backdrop for photographers to easily take to and from mobile locations for photography of various objections.

In accordance with at least select embodiments, a feature of the present disclosure is its ability to be folded up and easily transported.

Another feature of the present disclosure is its ability to be machine washed or dry cleaned.

A further feature of the present disclosure is its ability to give the user life-like printed textures, such as marble.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A photography backdrop comprising:
a cover including a first side and a second side with a pocket created therebetween; and
a base frame sized and shaped to fit in the pocket of the cover;
the base frame is collapsible to reconfigure the photography backdrop from a deployed backdrop state wherein the base frame supports the cover in a generally flat state to a compact state wherein the cover is folded.

2. The photography backdrop of claim 1, wherein:
when the photography backdrop is in the deployed backdrop state, the base frame stretches the cover into the generally flat state, whereby the photography backdrop may be positioned where the first side or the second side is a photography backdrop; and
when the photography backdrop is in the compact state, the photography backdrop is portable.

3. The photography backdrop of claim 1, wherein:
the first side has a first face with a first color, a first pattern, a first texture, or a first combination thereof; and
the second side has a second face with a second color, a second pattern, a second texture, or a second combination thereof;
wherein the first face is different from the second face, whereby the photography backdrop includes two different faces configured for providing two different photography backdrops.

4. The photography backdrop of claim 1, wherein the cover is made from a fabric material.

5. The photography backdrop of claim 4, wherein:
the first side is made from a first fabric material, the first fabric material includes a first face with a first color, a first pattern, a first texture, or a first combination thereof; and
the second side is made from a second fabric material, the second fabric material includes a second face with a second color, a second pattern, a second texture, or a second combination thereof;
wherein the first face is different from the second face, whereby the photography backdrop includes two different faces configured for providing two different photography backdrops.

6. The photography backdrop of claim 1, wherein:
the first side has a first perimeter;
and the second side has a second perimeter;
where, the first perimeter of the first side and the second perimeter of the second side are connected together with the pocket created therebetween inside the cover.

7. The photography backdrop of claim 6, wherein:
the first side is made from a first fabric material; and
the second side is made from a second fabric material;
wherein, the first perimeter of the first side and the second perimeter of the second side are sewn together by a sewn connection with the pocket created therebetween inside the cover;
wherein the first perimeter of the first side and the second perimeter of the second side are connected together with an openable portion configured for inserting and removing the base frame into and out of the pocket of the cover.

8. The photography backdrop of claim 7, wherein the openable portion includes a zippered opening configured to unzip for inserting and removing the base frame into and out of the pocket of the cover, wherein the base frame may be removed from the cover, whereby the cover is configured to be washed.

9. The photography backdrop of claim 1, wherein the cover and the base frame have a circular shape or an oval shape.

10. The photography backdrop of claim 1 further comprising a hanging mechanism, the hanging mechanism is configured to hang the photography backdrop on a surface.

11. The photography backdrop of claim 10, wherein the hanging mechanism including at least one loop connected to the cover.

12. The photography backdrop of claim 11, wherein the hanging mechanism including two loops connected to the cover.

13. The photography backdrop of claim 1, wherein the base frame is twistable into a plurality of stacked loops to reconfigure the base frame from the deployed backdrop state to the compact state, and vice versa.

14. A cover for a portable, foldable, washable photography backdrop including:
a first side and a second side with a pocket created therebetween;
the pocket is configured to receive a base frame collapsible to reconfigure the cover from a deployed backdrop state wherein the base frame supports the cover in a generally flat state to a compact state wherein the cover is folded.

15. The cover for a portable, foldable, washable photography backdrop of claim 14, wherein:
the first side is made from a first fabric material, the first fabric material includes a first face with a first color, a first pattern, a first texture, or a first combination thereof; and
the second side is made from a second fabric material, the second fabric material includes a second face with a second color, a second pattern, a second texture, or a second combination thereof;
wherein the first face is different from the second face, whereby the cover includes two different faces configured for providing two different photography backdrops;
the first side has a first perimeter;
and the second side has a second perimeter;
wherein, the first perimeter of the first side and the second perimeter of the second side are sewn together by a sewn connection with the pocket created therebetween inside the cover;
wherein the first perimeter of the first side and the second perimeter of the second side are sewn together with an openable portion configured for inserting and removing the base frame into and out of the pocket of the cover.

16. The cover for a portable, foldable, washable photography backdrop of claim 15, wherein the openable portion includes a zippered opening configured to unzip for inserting and removing the base frame into and out of the pocket of the cover, wherein the cover is configured to be washed.

17. The cover for a portable, foldable, washable photography backdrop of claim 14 further comprising a hanging mechanism, the hanging mechanism is configured to hang the cover on a surface.

18. The cover for a portable, foldable, washable photography backdrop of claim 17, wherein the hanging mechanism including two loops connected to the cover.

19. A method of using a photography backdrop including:
providing the photography backdrop including:
a cover including a first side and a second side with a pocket created therebetween; and
a base frame sized and shaped to fit in the pocket of the cover, the base frame is collapsible to reconfigure the provided photography backdrop from a deployed backdrop state wherein the base frame supports the cover in a generally flat state to a compact state wherein the cover is folded;
inserting the base frame into the pocket of the cover;
unfolding the base frame into the generally flat state for use as the photography backdrop; and
folding the base frame into the compact state for transportation.

20. The method of using a photography backdrop of claim 19 further including:
positioning the photography backdrop on the ground, or hanging the photography backdrop by a hanging mechanism included on the cover;
removing the base frame from the pocket of the cover, and washing the cover;
or
wherein, folding the base frame into the compact state for transportation includes twisting the base frame into a plurality of stacked loops to reconfigure the base frame from the deployed backdrop state to the compact state.
